(19) United States
(12) Patent Application Publication
(10) Pub. No.: US 2012/0156010 A1
(43) Pub. Date: Jun. 21, 2012

(54) BEARING STAND COVER OF AXIAL EXHAUST TURBINE, AND AXIAL EXHAUST TURBINE

(76) Inventor: Toshio MORIMOTO, Yokohama-shi (JP)

(21) Appl. No.: 13/302,790

(22) Filed: Nov. 22, 2011

(30) Foreign Application Priority Data
Nov. 26, 2010 (JP) 2010-264170

(51) Int. Cl. F03B 11/00

(52) U.S. Cl. 415/170.1

(57) ABSTRACT

According to an embodiment, an upper-side bearing cover 50a configuring a bearing stand cover 50 is provided with an upper-side large-diameter semicylindrical body 70 which is disposed to cover the periphery of a bearing stand 31 and has a semicylindrical shape with its one end closed, and an upper-side small-diameter semicylindrical body 71 having a semicylindrical shape which is integrally formed from the other open end of the upper-side large-diameter semicylindrical body 70 to cover a rear gland packing portion 40 and which has an outer diameter smaller than that of the upper-side large-diameter semicylindrical body 70. A reduced cylindrical body 72 is disposed between the upper-side large-diameter semicylindrical body 70 and the upper-side small-diameter semicylindrical body 71. An upper-side passage forming semicylindrical body 75 is configured as a different body to cover the peripheries of the upper-side small-diameter semicylindrical body 71 and the reduced cylindrical body 72.

### CROSS REFERENCE TO RELATED APPLICATION

This application is based upon and claims the benefit of priority from Japanese Patent Application No. 2010-264170, filed on Nov. 26, 2010; the entire contents of which are incorporated herein by reference.

### FIELD

Embodiments described herein relate generally to a bearing stand cover of an axial exhaust turbine and the axial exhaust turbine.

### BACKGROUND

In the axial exhaust turbine, a turbine rotor is supported by bearings disposed at axially both ends of the turbine rotor. A rear bearing, which is mounted on an exhaust side, between the above bearings is disposed within an exhaust casing.

Since the exhaust casing interior has a negative pressure while the axial exhaust turbine is operating, air and oil mist filling the interior of the bearing stand leak to a main steam exhaust passage 122 side through a through portion for the turbine rotor shaft. In order to prevent the leakage, a rear gland packing portion is provided at an upstream side (rotor blade side) of the bearing to seal the turbine rotor shaft. And, the bearing stand and the rear gland packing portion are covered by the bearing stand cover.

FIG. 4 is a view illustrating the structure inside an exhaust casing 110 when the exhaust casing 110 of a conventional axial exhaust turbine is viewed from its upper side. FIG. 4 partly shows cross sections of the exhaust casing 110, a bearing stand 114, a bearing stand cover 115, a turbine rotor 112, etc. to clearly show the interior structure of the exhaust casing 110. FIG. 5 is a perspective view showing a part of a bearing stand cover of the conventional axial exhaust turbine shown in FIG. 4.

As shown in FIG. 4, the exhaust casing 110 is mounted in the axial direction of the turbine rotor and coupled with a low pressure casing 111 which houses stationary blades and rotor blades on the low pressure side of the axial exhaust turbine. A bearing 113, which rotatably supports a shaft end portion of the turbine rotor 112, is mounted at the center within the exhaust casing 110. This bearing 113 is housed in the bearing stand 114. The bearing stand 114 is comprised of two split structures of an upper portion and a lower portion, and a flange portion 114a is formed along the outer peripheries of the individual split end portions. And, the split structures of the upper portion and the lower portion are mutually coupled by means of bolts and nuts through the flange portions 114a.

The bearing stand cover 115 is comprised of two split structures of an upper portion and a lower portion to cover the bearing stand 114 and a rear gland packing portion 116 as shown in FIG. 4. The bearing stand cover 115 is provided with a large-diameter cylindrical cover portion 118 which is comprised of a pair of semicylindrical bodies having an opening at one end on the side of a final stage rotor blade 117 and extended axially from the open end to the turbine rotor with the other end closed, and a small-diameter cylindrical cover portion 119 which is comprised of a pair of semicylindrical bodies disposed on the side of the final stage rotor blade 117 within the large-diameter cylindrical cover portion 118. The rear gland packing portion 116 is disposed on the inner peripheral surface of the small-diameter cylindrical cover portion 119. The semicylindrical bodies denote bodies resulting from splitting a cylindrical body into two bodies along its center axis.

In addition, the bearing stand cover 115 is provided with closed cover portions 120 and 121 which are disposed along a direction to intersect perpendicularly with the axial direction of the turbine rotor between the outer peripheries of both end portions of the small-diameter cylindrical cover portion 119 and the inner periphery of the large-diameter cylindrical cover portion 118 of the upper and lower portions. These closed cover portions 120 and 121 have a semicircular shape obtained by splitting an annular plate into two bodies. In the bearing stand cover on the lower side of the bearing stand cover 115, the space covered by the large-diameter cylindrical cover portion 118, the small-diameter cylindrical cover portion 119 and the closed cover portions 120 and 121 functions as a shaft seal steam chamber to flow steam to the rear gland packing portion 116.

The large-diameter cylindrical cover portion 118 is extended to the neighborhood of but not to contact to the final stage rotor blade 117 in such a way that main steam is suppressed from flowing to the rear gland packing portion 116 side and the main steam flowing along the large-diameter cylindrical cover portion 118 is made to flow appropriately.

Flange portions 115a and 115b are formed on the outer peripheries of split end portions of the split structures of the upper portion and the lower portion configuring the bearing stand cover 115. The split structures of the upper portion and the lower portion are mutually coupled by means of bolts and nuts via the flange portions 115a and 115b

Since the flange portion 115b is formed within the large-diameter cylindrical cover portion 118 as shown in FIG. 4 and FIG. 5, a worker needs to work within the large-diameter cylindrical cover portion 118 to couple the upper and lower portions by means of bolts and nuts. Therefore, an entrance 130, through which the worker enters onto the flange portion 115b, is formed at two positions in the circumferential direction of the upper-side large-diameter cylindrical cover portion 118. This entrance 130 is in an open state even when the axial exhaust turbine is operating.

Since the conventional bearing stand cover has both the function as the cover for the bearing stand and the rear gland packing portion and also the function to make the main steam flow appropriately, the open end of the large-diameter cylindrical cover portion is extended to the neighborhood of the final stage rotor blade as described above. Therefore, the entrance for entering into the large-diameter cylindrical cover portion in order to fasten the flange portion within it was needed to be formed on the large-diameter cylindrical cover portion.

In the axial exhaust turbine, the main steam having performed expansion work is exhausted through the annular exhaust passage between the exhaust casing and the bearing stand cover and lead to a condenser. But, there were problems that the main steam flowing along the bearing stand cover was disturbed by the entrance and a pressure loss was increased.

### BRIEF DESCRIPTION OF THE DRAWINGS

FIG. 1 is a view showing a meridional cross section of an exhaust portion of an axial exhaust turbine provided with a bearing stand cover according to an embodiment.

FIG. 2 is a view illustrating a structure of the exhaust portion when the axial exhaust turbine provided with the bearing stand cover according to the embodiment is viewed from above.

FIG. 3 is a perspective view showing a part of the bearing stand cover according to the embodiment.

FIG. 4 is a view illustrating a structure inside an exhaust casing when the exhaust casing of a conventional axial exhaust turbine is viewed from above.

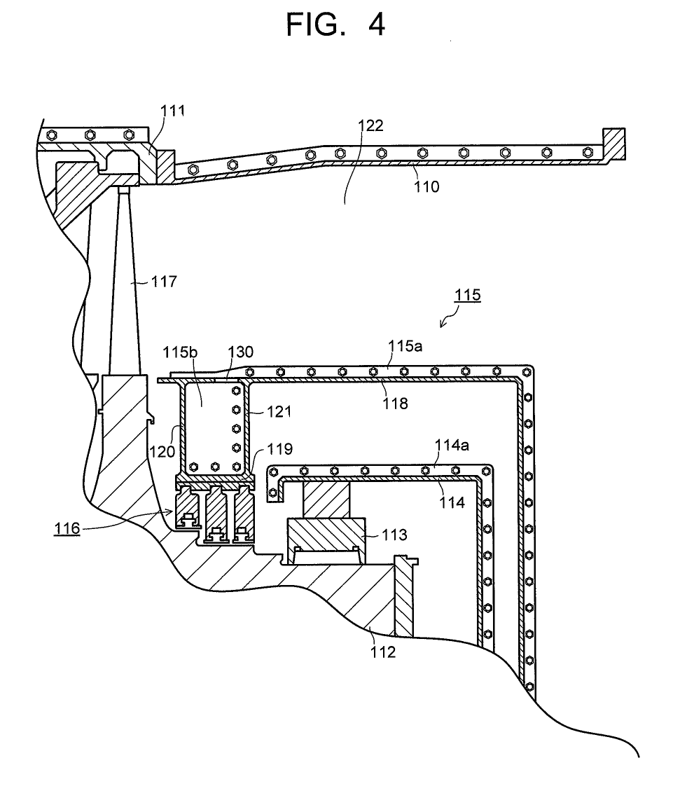

FIG. 5 is a perspective view showing a part of a bearing stand cover of the conventional axial exhaust turbine shown in FIG. 4.

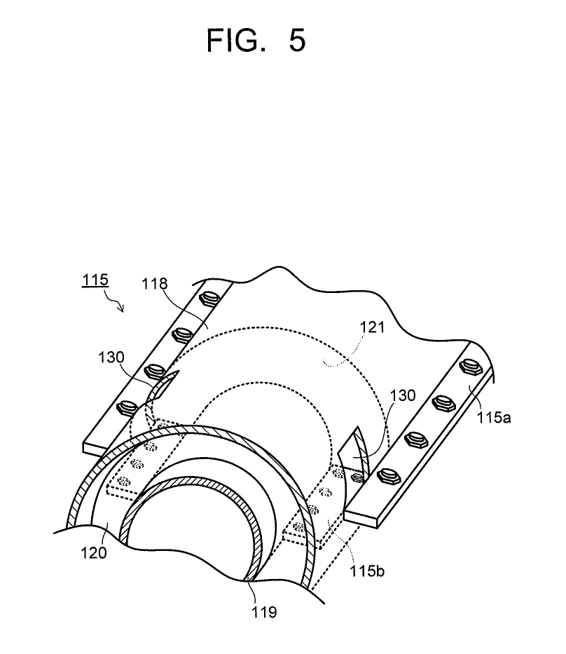

### DETAILED DESCRIPTION

In one embodiment, a bearing cover of an axial exhaust turbine is comprised of upper and lower two-split structures to configure an annular exhaust passage in cooperation with an exhaust casing of the axial exhaust turbine, and disposed to cover a bearing stand of a rear bearing and a rear gland packing portion provided at an upstream side of the bearing stand.

An upper-side bearing cover of the bearing cover, which is comprised of the upper and lower two-split structures, is provided with an upper-side large-diameter semicylindrical body which is disposed to cover the periphery of the bearing stand with its one end closed; an upper-side small-diameter semicylindrical body which is integrally formed from the other open end of the upper-side large-diameter semicylindrical body to cover the rear gland packing portion and has an outer diameter smaller than that of the upper-side large-diameter semicylindrical body; an upper-side body fastening flange which is formed on the outer periphery of a split end portion of an upper-side coaxial different diameter semicylindrical body comprised of the upper-side large-diameter semicylindrical body and the upper-side small-diameter semicylindrical body; an upper-side passage forming semicylindrical body which is configured as a different body independent of the upper-side coaxial different diameter semicylindrical body, has an outer diameter equal to that of the upper-side large--diameter semicylindrical body, covers the periphery of the upper-side small-diameter semicylindrical body, has its one end neighbored to the other end side of the upper-side large-diameter semicylindrical body, and has its other end extended to the neighborhood of a final stage rotor blade of the axial exhaust turbine; and a different body fastening flange which is formed on the outer periphery of a split end portion of the upper-side passage forming semicylindrical body.

A lower-side bearing cover of the bearing cover, which is comprised of the upper and lower two-split structures, is provided with a lower-side large-diameter semicylindrical body which is disposed to cover the periphery of the bearing stand with its one end closed, has its other end extended to the neighborhood of a final stage rotor blade of the axial exhaust turbine and has an outer diameter equal to that of the upper-side large-diameter semicylindrical body; a lower-side small-diameter semicylindrical body which is disposed to cover the rear gland packing portion within the lower-side large-diameter semicylindrical body and has an outer diameter equal to that of the upper-side small-diameter semicylindrical body; a closing member which is disposed in a direction to intersect perpendicularly with the axial direction of the turbine rotor between the outer peripheries of both end portions of the lower-side small-diameter semicylindrical body and the inner periphery of the lower-side large-diameter semicylindrical body and configures a shaft seal steam chamber in cooperation with the lower-side small-diameter semicylindrical body and the lower-side large-diameter semicylindrical body; and a lower-side body fastening flange which is formed at least along the outer periphery of a split end portion of the lower-side large-diameter semicylindrical body and both end portions in a circumferential direction of the shaft seal steam chamber and fastened with the upper-side body fastening flange and the different body fastening flange from the exhaust passage side.

Embodiments of the invention are described below with reference to the drawings.

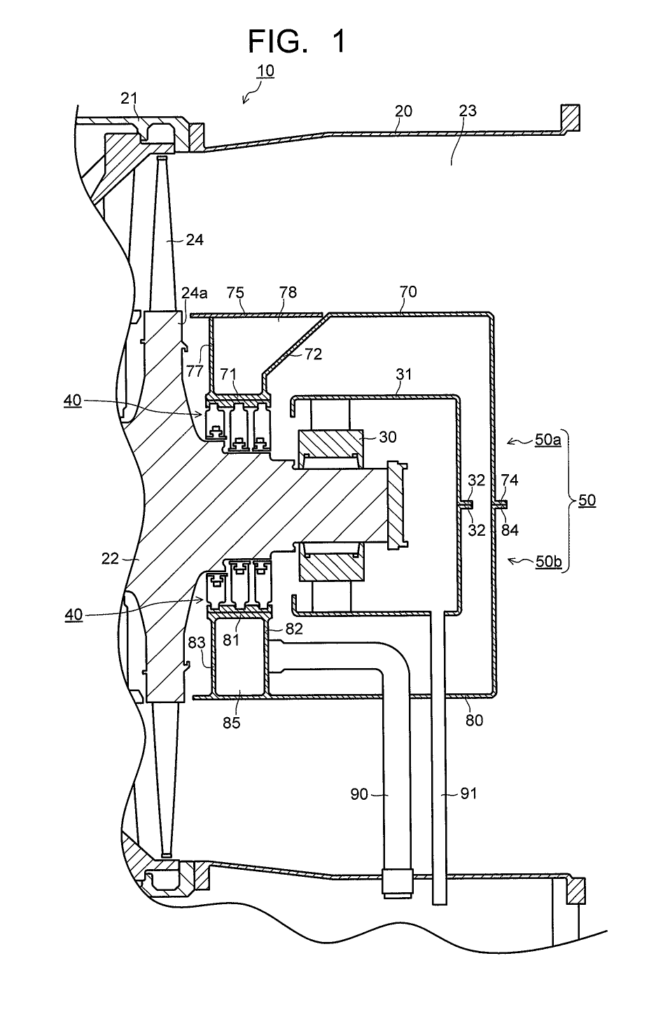

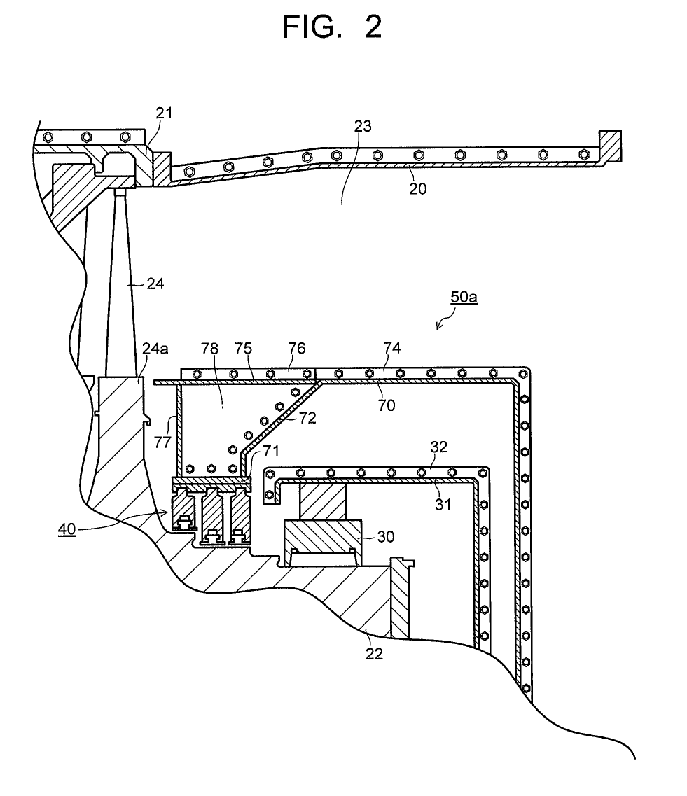

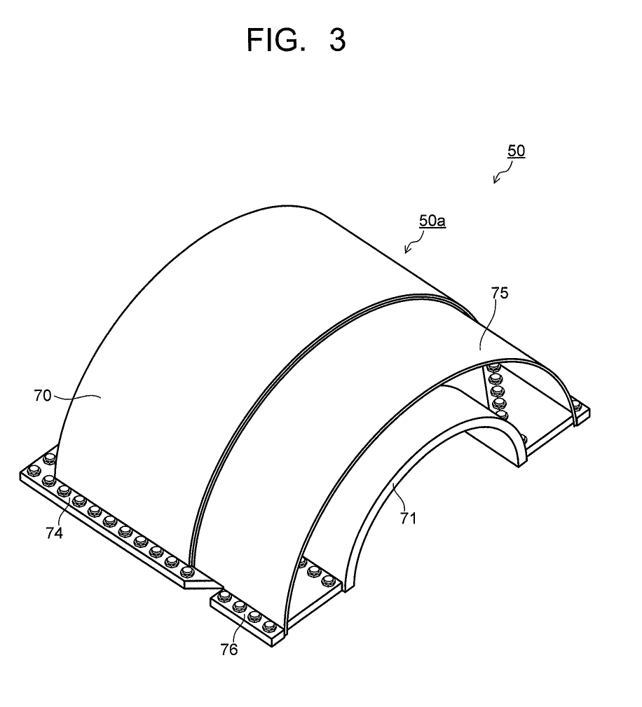

FIG. 1 is a view showing a meridional cross section of an exhaust portion of an axial exhaust turbine 10 provided with a bearing stand cover 50 according to an embodiment. FIG. 2 is a view illustrating a structure of an exhaust portion when the axial exhaust turbine 10 provided with the bearing stand cover 50 of the embodiment is viewed from above. FIG. 2 partly shows cross sections of an upper-side exhaust casing 20, a bearing stand 31, the bearing stand cover 50, a turbine rotor 22 and the like to clearly show the inside structure of the exhaust casing 20. FIG, 3 is a perspective view showing a part of the bearing stand cover 50 according to the embodiment. In addition, in FIG. 3, a closing member 77 is omitted.

As shown in FIG. 1, the exhaust casing 20 of the axial exhaust turbine 10 is disposed coupled to a low pressure casing 21, which houses stationary blades and rotor blades on a low pressure side of the axial exhaust turbine 10, in the axial direction of the turbine rotor. A bearing 30 is disposed at the center in the exhaust casing 20 to support rotatably a shaft end portion of the turbine rotor 22. The bearing 30 is housed in the bearing stand 31. The bearing stand 31 is constituted by two split structures including an upper portion and a lower portion, and a fastening flange portion 32 is formed along the outer peripheries of the individual split end portions as shown in FIG. 2 and FIG. 3. And, the structures of the upper portion and the lower portion are mutually coupled through the fastening flange portion 32 by means of bolts and nuts.

The bearing stand cover 50 comprised of the two split structures of the upper portion and the lower portion is disposed to surround the bearing stand 31. The bearing stand cover 50 is constructed to cover the periphery of a rear gland packing portion 40, which is disposed on the upstream side (rotor blade 24 side) of the bearing 30 in addition to the periphery of the bearing stand 31, to prevent air and oil mist filled within the bearing stand from leaking to an exhaust passage side.

As shown in FIG. 1 and FIG. 2, an annular exhaust passage 23 is formed between the bearing stand cover 50 and the exhaust casing 20.

The structure of the bearing stand cover 50 is described below with reference to FIG. 1, FIG. 2 and FIG. 3.

The bearing stand cover 50 is comprised of the two split structures of the upper portion and the lower portion. An upper side bearing cover 50a of the bearing cover, which is comprised of the upper and lower two-split structures, is described about its structure.

The upper-side bearing cover 50a is provided with an upper-side large-diameter semicylindrical body 70 having a semicylindrical shape with one end closed which is disposed to cover the periphery of the bearing stand 31, and an upper-side small-diameter semicylindrical body 71 having a semicylindrical shape which is integrally formed from the other open end of the upper-side large-diameter semicylindrical body 70 to cover the rear gland packing portion 40 and has an outer diameter smaller than that of the upper-side large-diameter semicylindrical body 70. Here, the semicylindrical shape denotes a shape resulting from splitting a cylindrical body into two bodies along its center axis. A packing box, which holds a labyrinth packing configuring the rear gland packing portion 40, may be formed on an inner peripheral surface of the upper-side small-diameter semicylindrical body 71.

A reduced cylindrical body 72, of which outer diameter decreases gradually from the other end of the upper-side large-diameter semicylindrical body 70 toward the one end of the upper-side small-diameter semicylindrical body 71, is preferably formed between the other end of the upper-side large-diameter semicylindrical body 70 and the one end of the upper-side small-diameter semicylindrical body 71. The reduced cylindrical body 72 has an outer diameter smaller than that of the upper--side large-diameter semicylindrical body 70 and functions as part of the structure of the upper-side small-diameter semicylindrical body 71. A wall formed in a direction to intersect perpendicularly with the axial direction of the turbine rotor, can also be constructed between the other end of the upper-side large-diameter semicylindrical body 70 and the one end of the upper-side small-diameter semicylindrical body 71. In other words, a wall which intersects perpendicularly with the axial direction of the turbine rotor, may be formed from the other end of the upper-side large-diameter semicylindrical body 70 toward the one end of the upper-side small-diameter semicylindrical body 71.

It is preferable to configure the reduced cylindrical body 72 between the other end of the upper-side large-diameter semicylindrical body 70 and the one end of the upper-side small-diameter semicylindrical body 71 as described above, because a fastening flange described later can be formed to be short in comparison with the structure that the wall is formed between them along the direction to intersect perpendicularly with the axial direction of the turbine rotor, and the fastened regions where leakage occurs can be decreased. Since the fastening flange can be formed short, the quantity of fastening members such as bolts and nuts used can be reduced.

It is determined that an inclined angle (angle of an inclined wall surface configuring the reduced cylindrical body 72 with respect to a horizontal direction) of the reduced cylindrical body 72 is approximately 45 degrees, but it is not limited to a particular angle but can be varied as required depending on the specifications of the axial exhaust turbine 10. A structure that the inclined angle is 90 degrees corresponds to the above-described structure that the wall extending in the direction to intersect perpendicularly with the axial direction of the turbine rotor is formed between the other end of the upper-side large-diameter semicylindrical body 70 and the one end of the upper-side small-diameter semicylindrical body 71. An upper-side coaxial different diameter semicylindrical body comprising the upper-side large-diameter semicylindrical body 70, the upper-side small-diameter semicylindrical body 71 and the reduced cylindrical body 72 is integrally formed by welding between the individual semicylindrical bodies.

An upper-side body fastening flange 74 having a prescribed width is formed along the outer periphery of the split end portion of the upper-side coaxial different diameter semicylindrical body as shown in FIG. 2 and FIG. 3. Fastening holes are opened at a predetermined pitch in the upper-side body fastening flange 74. It is preferable that the upper-side body fastening flange 74 formed along the outer peripheries of the upper-side small-diameter semicylindrical body 71 and the reduced cylindrical body 72 of the upper-side coaxial different diameter semicylindrical body is configured to have a large flange width so as to seal between the upper-side small-diameter semicylindrical body 71 and an upper-side passage forming semicylindrical body 75 described later. By configuring in this way, the worker can perform the fastening work on the flange with a sufficient working space provided.

The bearing stand cover 50 is provided with an upper-side passage forming semicylindrical body 75, which is configured as a different body independent of the upper-side coaxial different diameter semicylindrical body, to cover the peripheries of the upper-side small-diameter semicylindrical body 71 and the reduced cylindrical body 72. This upper-side passage forming semicylindrical body 75 has an outer diameter equal to that of the upper-side large-diameter semicylindrical body 70, has its one end neighbored to the other end of the upper-side large-diameter semicylindrical body 70, and has the other end extended to the neighborhood of but not to contact to a rotor disk 24a on which the final stage rotor blade 24 of the axial exhaust turbine 10 is implanted. The central axis of the upper-side passage forming semicylindrical body 75 is coaxial with that of the upper-side coaxial different diameter semicylindrical body. In other words, an outer peripheral surface of the upper-side passage forming semicylindrical body 75 and an outer peripheral surface of the upper-side large-diameter semicylindrical body 70 configure a continuous peripheral surface in the exhaust direction of the exhaust passage 23 as shown in FIG. 1, FIG. 2 and FIG. 3.

A different body fastening flange 76 having a prescribed width is formed along the outer periphery of the split end portion of the upper-side passage forming semicylindrical body 75 as shown in FIG. 2 and FIG. 3. Fastening holes are opened at a predetermined pitch in this different body fastening flange 76.

Since the other end of the upper-side passage forming semicylindrical body 75 is extended to the neighborhood of the rotor disk 24a on which the rotor blade 24 is implanted, steam is suppressed from flowing from between the rotor disk 24a and the upper-side passage forming semicylindrical body 75 into the upper-side passage forming semicylindrical body 75. And, since the upper-side passage forming semicylindrical body 75 is disposed, the steam having passed by the final stage rotor blade 24 is not disturbed on the surface of the upper-side passage forming semicylindrical body 75 but made to flow appropriately to downstream.

As shown in FIG. 1 and FIG. 2, an open end portion of an annular space 78, which is formed between the upper-side small-diameter semicylindrical body 71 and the upper-side passage forming semicylindrical body 75, on the rotor blade 24 side, may be closed by a closing member 77. The closing member 77 has a semi-ring shape which is formed by splitting an annular plate into two, and it is fixed to at least one of the outer periphery of the upper-side small-diameter semicylindrical body 71 and the inner periphery of the upper-side passage forming semicylindrical body 75. Thus, when the open end portion is closed by the closing member 77 as described above, the space downstream of the rotor disk 24a, on which the final stage rotor blade 24 of the axial exhaust turbine 10 is implanted, is reduced, and the sealing effect by the rear gland packing portion 40 is enhanced.

The structure of a lower-side bearing cover 50b of the bearing cover, which is comprised of the upper and lower two-split structures, is described below.

The lower-side bearing cover 50b is provided with a lower-side large-diameter semicylindrical body 80, which is disposed to cover the periphery of the bearing stand 31 with its one end closed, and its other end is extended to the neighborhood of but not to contact to the rotor disk 24a on which the final stage rotor blade 24 of the axial exhaust turbine 10 is implanted. This lower-side large-diameter semicylindrical body 80 has an outer diameter equal to that of the upper-side large-diameter semicylindrical body 70.

The lower-side bearing cover 50b is also provided with a lower-side small-diameter semicylindrical body 81 which is disposed to cover the rear gland packing portion 40 within the lower-side large-diameter semicylindrical body 80.

The lower-side small-diameter semicylindrical body 81 has an outer diameter equal to that of the upper-side small-diameter semicylindrical body 71. And, a packing box having a labyrinth packing configuring the rear gland packing portion 40 may be formed on the inner peripheral surface of the lower-side small-diameter semicylindrical body 81.

Closing members 82 and 83 are disposed in a direction to intersect perpendicularly with the axial direction of the turbine rotor between the outer peripheries of both end portions of the lower-side small-diameter semicylindrical body 81 and the inner periphery of the lower-side large-diameter semicylindrical body 80. These closing members 82 and 83 have a semi-ring shape which is formed by splitting an annular plate into two, and are fixed between the outer periphery of the lower-side small-diameter semicylindrical body 81 and the inner periphery of the lower-side large-diameter semicylindrical body 80 by welding or the like. And, both end portions in a circumferential direction of the region between the closing member 82 and the closing member 83 are sealed by a sealing member (not shown). The sealing member, the closing members 82 and 83, the lower-side small-diameter semicylindrical body 81 and the lower-side large-diameter semicylindrical body 80 configure a shaft seal steam chamber 85 to flow steam to the rear gland packing portion 40. As shown in FIG. 1, a steam pipe 90 for supplying steam to the shaft seal steam chamber 85 and a steam pipe (not shown) for exhausting the steam from the shaft seal steam chamber are connected to a steam system which is disposed outside through the lower-side large-diameter semicylindrical body 80 and the exhaust casing 20.

As shown in FIG. 1, the bearing stand 31 is provided with an equalizing pipe 91, which opens an inner space of the bearing stand 31 to the atmosphere, through the lower-side large-diameter semicylindrical body 80 and the exhaust casing 20.

Here, a lower-side body fastening flange 84 having a predetermined width is formed along the outer periphery of the split end portion of the lower-side large-diameter semicylindrical body 80 and fastened with the upper-side body fastening flange 74 and the different body fastening flange 76. And, the sealing member (not shown) configuring the above-described shaft seal steam chamber 85 also functions as the lower-side body fastening flange 84 and is fastened with the upper-side body fastening flange 74 which is formed on the outer peripheries of the upper-side small-diameter semicylindrical body 71 and the reduced cylindrical body 72.

To fasten with the upper-side body fastening flange 74 formed on the outer periphery of the reduced cylindrical body 72 of the upper-side coaxial different diameter semicylindrical body, a fastening flange (not shown) is also formed on a position corresponding to the upper-side body fastening flange 74 of the reduced cylindrical body 72 within the lower-side large-diameter semicylindrical body 80.

To assemble the bearing stand cover 50, the upper-side body fastening flange 74 of the upper-side coaxial different diameter semicylindrical body and the lower-side body fastening flange 84 of the lower-side large-diameter semicylindrical body 80 are fastened mutually. Subsequently, the upper-side passage forming semicylindrical body 75 is disposed, and a different body fastening flange 76 of the upper-side passage forming semicylindrical body 75 and the lower-side body fastening flange 84 of the lower-side large-diameter semicylindrical body 80 are fastened mutually from the exhaust passage 23 side. Thus, the bearing stand cover 50 is assembled.

According to the axial exhaust turbine 10 provided with the bearing stand cover 50 of the embodiment described above, the upper-side passage forming semicylindrical body 75 is formed as a different body independent of the upper-side coaxial different diameter semicylindrical body. Therefore, even when the portion covered by the upper-side passage forming semicylindrical body 75 is provided with the fastening flange, it is not necessary to form the entrance for the worker into the upper-side passage forming semicylindrical body 75, and the fastening flange of the portion covered by the upper-side passage forming semicylindrical body 75 can be fastened prior to the installation of the upper-side passage forming semicylindrical body 75.

By configuring as described above, the generation of the disturbance of the main stream due to the provision of the entrance can be avoided, and a pressure loss within the exhaust passage 23 can be reduced.

According to the embodiment described above, it becomes possible to suppress the pressure loss in the exhaust casing from increasing.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A bearing stand cover of an axial exhaust turbine, configured to be comprised of upper and lower two-split structures to configure an annular exhaust passage in cooperation with an exhaust casing of the axial exhaust turbine, and disposed to cover a bearing stand of a rear bearing and a rear gland packing portion provided at an upstream side of the bearing stand,
wherein an upper-side bearing cover of the bearing cover, which is comprised of the upper and lower two-split structures, is provided with:
an upper-side large-diameter semicylindrical body which is disposed to cover the periphery of the bearing stand with its one end closed;
an upper-side small-diameter semicylindrical body which is integrally formed from the other open end of the upper-side large-diameter semicylindrical body to cover the rear gland packing portion and has an outer diameter smaller than that of the upper-side large-diameter semicylindrical body;
an upper-side body fastening flange which is formed on the outer periphery of a split end portion of an upper-side coaxial different diameter semicylindrical body comprised of the upper-side large-diameter semicylindrical body and the upper-side small-diameter semicylindrical body;
an upper-side passage forming semicylindrical body which is configured as a different body independent of the upper-side coaxial different diameter semicylindrical body, has an outer diameter equal to that of the upper-side large-diameter semicylindrical body, covers the periphery of the upper-side small-diameter semicylindrical body, has its one end neighbored to the other end side of the upper-side large-diameter semicylindrical body and has its other end extended to the neighborhood of a final stage rotor blade of the axial exhaust turbine; and
a different body fastening flange which is formed on the outer periphery of a split end portion of the upper-side passage forming semicylindrical body; and
wherein a lower-side bearing cover of the bearing cover, which is comprised of the upper and lower two-split structures, is provided with:
a lower-side large-diameter semicylindrical body which is disposed to cover the periphery of the bearing stand with its one end closed, has its other end extended to the neighborhood of a final stage rotor blade of the axial exhaust turbine and has an outer diameter equal to that of the upper-side large-diameter semicylindrical body;
a lower-side small-diameter semicylindrical body which is disposed to cover the rear gland packing portion within the lower-side large-diameter semicylindrical body and has an outer diameter equal to that of the upper-side small-diameter semicylindrical body;
a closing member which is disposed in a direction to intersect perpendicularly with the axial direction of the turbine rotor between the outer peripheries of both end portions of the lower-side small-diameter semicylindrical body and the inner periphery of the lower-side large-diameter semicylindrical body and configures a shaft seal steam chamber in cooperation with the lower-side small-diameter semicylindrical body and the lower-side large-diameter semicylindrical body; and
a lower-side body fastening flange which is formed at least along the outer periphery of a split end portion of the lower-side large-diameter semicylindrical body and both end portions in a circumferential direction of the shaft seal steam chamber and fastened with the upper-side body fastening flange and the different body fastening flange from the exhaust passage side.

2. The bearing stand cover according to claim 1,
wherein a closing member is disposed to close an open end portion on the rotor blade side in an annular space formed between the upper-side small-diameter semicylindrical body and the upper-side passage forming semicylindrical body.

3. An axial exhaust turbine provided with the bearing stand cover according to claim 1 or 2.
